(19) United States
(12) Patent Application Publication
(10) Pub. No.: US 2025/0068406 A1
(43) Pub. Date: Feb. 27, 2025

(54) EXPORT PROCESS FROM CLOUD ENVIRONMENT

(71) Applicant: BUSINESS OBJECTS SOFTWARE LTD., DUBLIN (IE)

(72) Inventors: Mateusz LEWANDOWSKI, Abbeyleix (PL); Paul SHEEDY, Dublin (IE); Paul O'CONNOR, Lucan (IE)

(21) Appl. No.: 18/452,716

(22) Filed: Aug. 21, 2023

(51) Int. Cl. G06F 8/61; G06F 9/38; H04L 67/00

(52) U.S. Cl. CPC G06F 8/61; G06F 9/3838; H04L 67/34

(57) ABSTRACT

Provided are systems and methods for importing application content from a cloud environment where the application is being hosted onto a local user device. In one example, the method may include receiving, at a user device, a package exported from a host platform, extracting content of a software application hosted on the host platform and a script from the exported package, invoking the script within a runtime environment on the user device, and causing, via the script, a transfer objects of cloud content of the software application which are included in the exported package to a file system that is installed in a local storage on the user device.

### BACKGROUND

Software testing is a fundamental phase of any software development lifecycle. For example, testing can be used to ensure that the software performs properly and delivers reliable outputs and features. During the development process, it is essential to test the software prior to commercial delivery. For software that is hosted inside a cloud environment on a cloud platform, the software is typically tested by a user that is coupled to the platform locally. However, testing software inside a cloud environment comes with drawbacks including a lack of security and privacy of the data, hard to understand service level agreements (SLAs), lack of standardization around integrating public cloud resources, limited testing and configuration options, difficulty testing the entire system, bandwidth strain, and the like.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings.

FIG. 1A is a diagram illustrating a process of exporting a package from a host platform to a user device in accordance with an example embodiment.

FIG. 1B is a diagram illustrating a process of storing content from the package in a local file system of the user device in accordance with an example embodiment.

FIG. 1C is a diagram illustrating a process of interacting with cloud content locally on the user device in accordance with an example embodiment.

FIG. 2 is a diagram illustrating a communication sequence for importing content into a local file system of the user device in accordance with an example embodiment.

FIG. 3 is a diagram illustrating a process of a script transferring objects of content downloaded from the cloud into the local file system on the user device in accordance with an example embodiment.

FIG. 4 is a diagram illustrating a method of importing content from a host platform to a user device in accordance with an example embodiment.

FIG. 5 is a diagram illustrating a computing system for use with any of the examples herein in accordance with an example embodiment

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Traditionally, software applications were developed and hosted by “on-premises” systems which require the developer to perform all the installation, maintenance, testing, etc. of a software application in a local computing environment. Recently, organizations have begun moving their software applications and data from an on-premises environment to a cloud environment. A cloud platform includes a different runtime environment than the on-premises systems. For example, a cloud platform may include a JavaScript (Node.js runtime) environment, or the like.

Cloud platforms let anyone deploy network applications or services and make them available to the world in a few minutes. When an application becomes popular, the cloud can scale the application (i.e., add more instances, etc.) to handle more traffic, and replace build-out and migration efforts that once took months with a few keystrokes. Cloud platforms enable a software developer to focus exclusively on the application and data without worrying about underlying infrastructure. Each instance of an application deployed to a runtime environment (e.g., such as provided by CLOUD FOUNDRY®, etc.) runs within its own self-contained environment, referred to as a container. The container isolates processes, memory, and the filesystem using operating system features and the characteristics of the virtual and physical infrastructure where the cloud is deployed.

The example embodiments are directed to a process for importing content, such as business data used by a software application (e.g., files, database tables, documents, etc.) from a host platform such as a cloud platform into a local storage environment (such as a local user device). The process may include an export process where instructions for importing content into the local file system on the user device are exported out of the cloud to the user device. Here, a user may access the cloud from a remote device such as a personal computer, a laptop, a mobile device, or the like, and export/download a package (e.g., zip file, etc.) from the cloud which includes an executable script, cloud content, and metadata with import instructions. The remote device may unzip the package, extract the content, execute the script, and store the content on its own local file system thus enabling local access to the cloud content. The access can even be offline and the script will still work. For example, the cloud content that is downloaded from the cloud may be in the form of a package which contains metadata including a description of the objects to be imported. Here, the script imports this content to a database/file system on a local user device such as a laptop, tablet, smart phone, etc. thereby enabling access to the cloud content even when the local user device is offline.

With the cloud content downloaded to their device, the user may interact with the content locally while offline or online. For example, the user may use an input mechanism (e.g., mouse, keyboard, speech, etc.) coupled to the remote device to input commands, values, etc., and use the cloud content such as for testing software, evaluating model performance, debugging, and the like. This process may even be carried out while the user device is offline without access to a computer network such as the Internet. The content may be stored within a local file system on the user device. The script may be granted access to the directory where the content is stored within the file system. As the user interacts with the content, the cloud content used by the software may be pulled from the local file system of the user device instead of the cloud.

The import process into the local file system on the user device may begin with the user entering a command on a user interface, etc., which invokes the script that was downloaded from the cloud. In response, the script may read the metadata to identify the objects that have been downloaded from the cloud/host platform which are to be imported into the local file system on the user device. The script may then generate a list of objects (files) from the cloud content based on metadata that was exported out of the cloud with the package and transfer the objects to the local file system based on the generated list.

The transfer process may be carried out locally within the user device. Here, the imported objects are ordered based on dependencies included in the metadata, and sent in sequential order (e.g., a serial transfer) from the script to the local file system. In some embodiments, the cloud content may be downloaded via an application programming interface (API) of the cloud platform/cloud storage such as a representational state transfer (REST) API. The API may include an endpoint that is a destination target of HTTP requests for content from the user device. On import completion, the uploaded content can be cleaned up and stored within the local file system on the user device.

In some embodiments, the package that is downloaded from the cloud may be downloaded via an Analytic Content Network (ACN) network/microservice that is hosted in the cloud. The ACN network may transfer cloud data including the export package to the user device. The ACN network may be hosted within the cloud and may be accessed by the ACN microservice described herein. The ACN also provides a layer of abstraction between the format of the data stored on the cloud and the format of the data stored on the local file system.

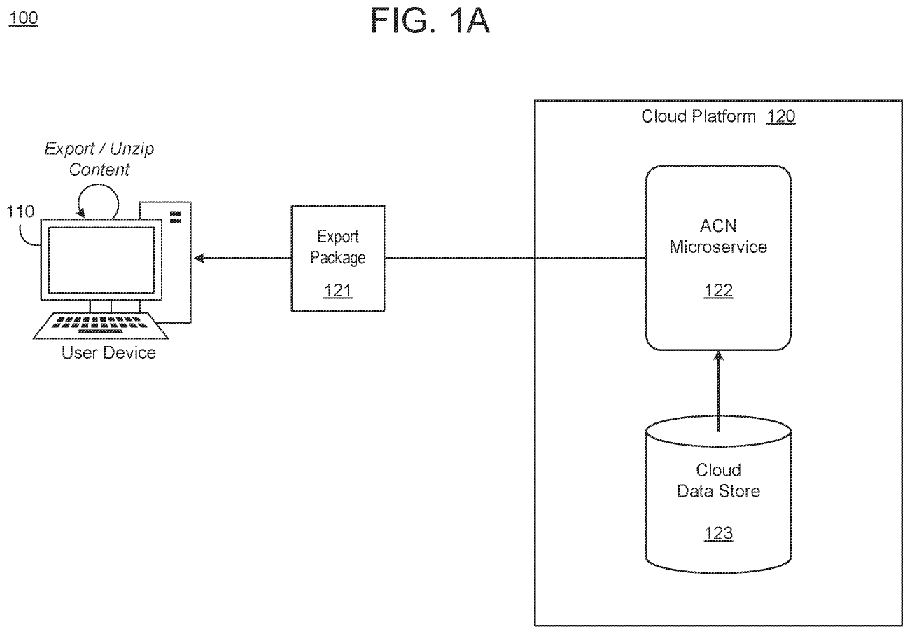

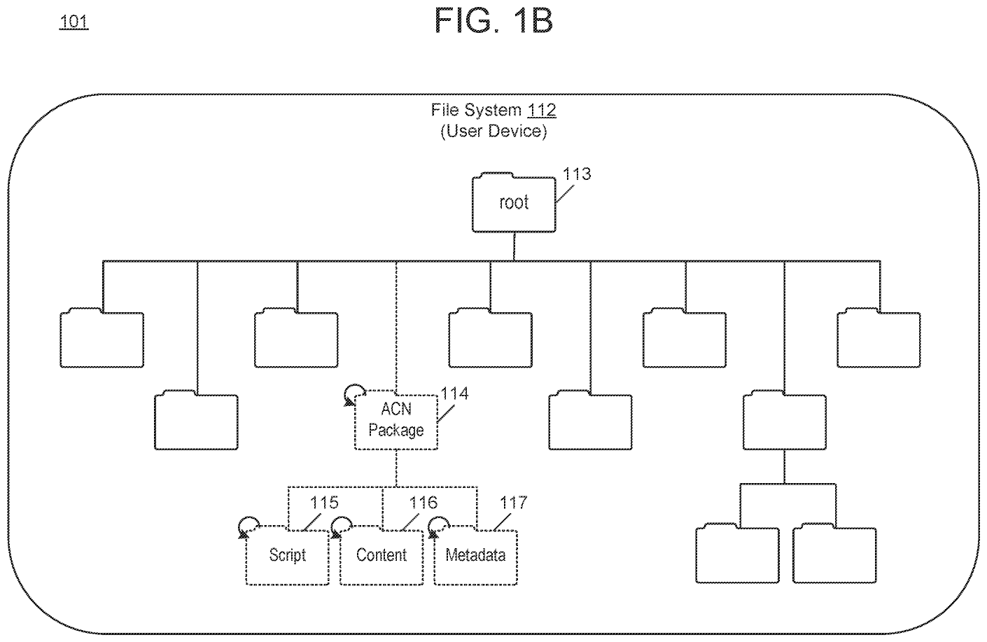

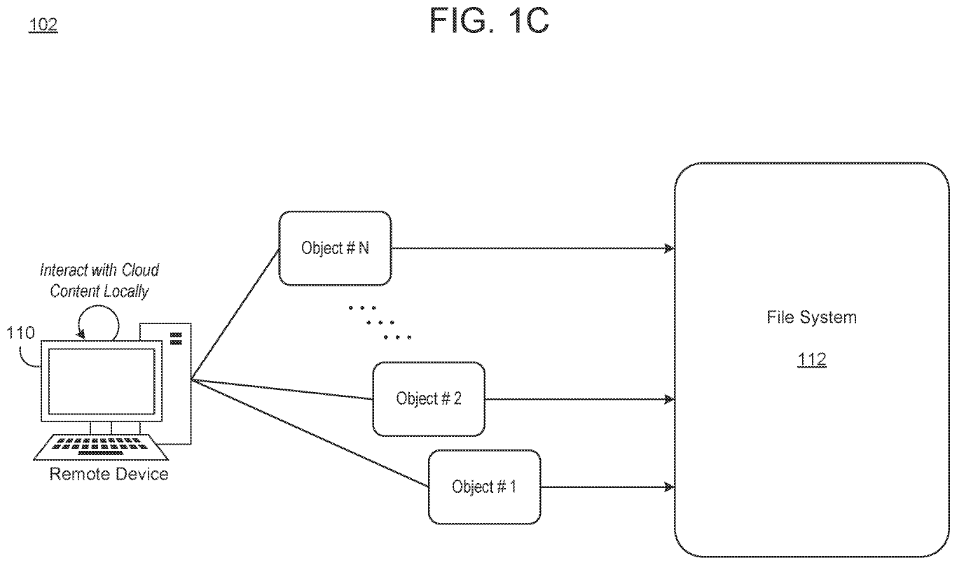

FIGS. 1A-1C illustrate the end-to-end import process. The process begins with an export of a package of content from the cloud. Within the exported package is an executable script (e.g., a node JS process) that can be installed locally on the user device and executed by the user device to transfer the cloud content into the local file system on the user device. The script can implement a workflow to import content from the cloud platform into the file system.

FIG. 1A illustrates a process 100 of exporting a package 121 from a cloud platform 120 to a user device 110 in accordance with an example embodiment. Referring to FIG. 1A, the user device 110 may access the cloud platform 120 via a computer network, not shown. For example, the user device 110 may be a personal computer, a laptop, a tablet, a mobile device, an on-premises server, or the like, and may include a browser or other mechanism which enables the user device 110 to access an endpoint offered by a microservice 122 hosted by the cloud platform 120. Meanwhile, the cloud platform 120 may refer to a cloud platform or the like. To establish a connection, the user device 110 may be required to login or otherwise provide verifying credentials to the microservice 122 before being granted access.

In the example of FIG. 1A, the user device 110 may send a request for content to the microservice 122. The microservice 122 may respond with a package 121 of files that are exported out of the host platform (such as cloud data store 123). The package 121 may include an import script (also referred to herein as an ACN script) which can be executed by the user device 110. The package 121 may also include application content (e.g., business data, etc.) downloaded from the cloud which may include files, tables, documents, and the like. The package 121 may also include metadata with instructions for the script to use to import the application content back to the cloud platform 120. In some embodiments, the package 121 may be zipped by the microservice 122 prior to export in order to reduce the amount of data transmitted over the network.

In response to receiving the package 121 from the microservice 122, the user device 110 may unzip the package 121 and extract the content therein. Furthermore, the content can be saved onto the user device 110. Once the content has been saved onto the user device 110, the user can work on the cloud content locally even when the user device 110 is not connected to the cloud platform 120 or a network at all. For example, FIG. 1B illustrates a process 101 of storing content from the package 121 in a file system 112 that is local to the user device 110 in accordance with an example embodiment. As shown in this example, the content downloaded within the package 121 includes a script, cloud content, and metadata.

In FIG. 1B, the file system 112 includes a root directory 113 with additional sub-directories (e.g., folders, etc.) of files. The user device 110 may install one or more of a folder, directory, file, etc. for the exported content within the file system 112 on the user device 110. In the example of FIG. 1B, the user device 110 installs a sub-directory 114 with a folder 115 with an executable for a script, a folder 116 with cloud content downloaded from the cloud platform 120 such as application content, and a folder 117 with metadata that includes instructions for importing the content back to the cloud platform 120. The user device 110 may then ensure that the script has access to the sub-directory 114 when it executes, for example, by registering the sub-directory (or files in the sub-directory) in the script's import list.

The package 121 exported out of the cloud platform 120 may be unzipped/unarchived by the user device 110 and decoded based on base64 decoding. The unzipped content may be parsed to expose cloud content in the form of files (cloud data artifacts) which have been downloaded from the cloud, a script, and metadata which identifies a list of artifacts that are to be imported to the cloud platform 120 upon import of the cloud content downloaded from the host platform. For example, the metadata within the package 121 may identify a list of objects (e.g., tables, documents, dimensions, etc.) which are to be converted into objects and imported to the cloud platform 120. These same tables and other objects may initially be downloaded from the cloud platform 120 and used locally on the user device 110. The user may change the data stopped within the files, for example, by changing the data values within the data. The user may then import the changed data into the cloud.

With the cloud content now on their local system (user device 110), the user, such as a software developer, may make changes to the content. For example, values, data, etc., within the cloud content may be changed. This process may even be carried out while the user device 110 is offline. The script may be invoked on the user device 110 by running an import command such as a node package manager (npm) command via a command line. In response, the script may process the import list and return the files in the file system (including any modifications to the cloud content) back to the cloud as further described herein.

FIG. 1C illustrates a process 102 of importing content exported out of the cloud platform 120 into a local file system on a user device in accordance with an example embodiment. Referring to FIG. 1C, once installed, the script may be executed/invoked by the user device. Here, the script may read a list of data objects that are to be imported into the local file system of the user device 110 based on the metadata that is downloaded with the package 121 exported in FIG. 1A. Here, the script may identify a list of objects (cloud content) and an ordering among the objects which can be critical to ensure proper import of the data. For example, a first object may identify a table and a second object may identify dimensions within the table. If the dimension object were imported prior to the table object, the dimension would not be applicable because the table would not exist. These dependencies may be preserved when the data objects are imported/uploaded to the cloud to prevent such issues.

Based on the order, the script may send each data artifact (e.g., table, dimension, etc.) to the file system 112 on the user device 110. In this example, each of the data artifacts may be converted into an object format via an ACN network by the script. Here, the conversion may occur on the user device 110, at the cloud platform 120, or the like. The objects may then be serially transmitted (i.e., in sequential order) to the file system 112 that is local on the user device 110. The objects may be stored directly in the file system in a format that is different than how it was stored in the cloud platform. For example, the cloud may store data in the form of blobs or other formats while the file system 112 on the user device 110 stores data in the form of files which are accessed via file paths. The ACN network within the cloud may convert data from one form to another to prior to delivery to the user device 110 to ensure that the data can be properly stored within the file system 112 on the user device 110. As another example, the ACN network may be executed by the script locally on the user device 110.

Traditionally, the ability to modify data stored in a cloud storage environment is limited to applications, services, and other programs that are running locally within the cloud. Because of this, external users are unable to test software and perform other cloud-based actions outside of the cloud platform. The present application overcomes these drawbacks and enables a remote device, such as a user's personal device or travelling computer to be used to import data directly from the cloud into a local storage on the user device 110 and used without a need to connect to or access the data/content from the cloud platform 120.

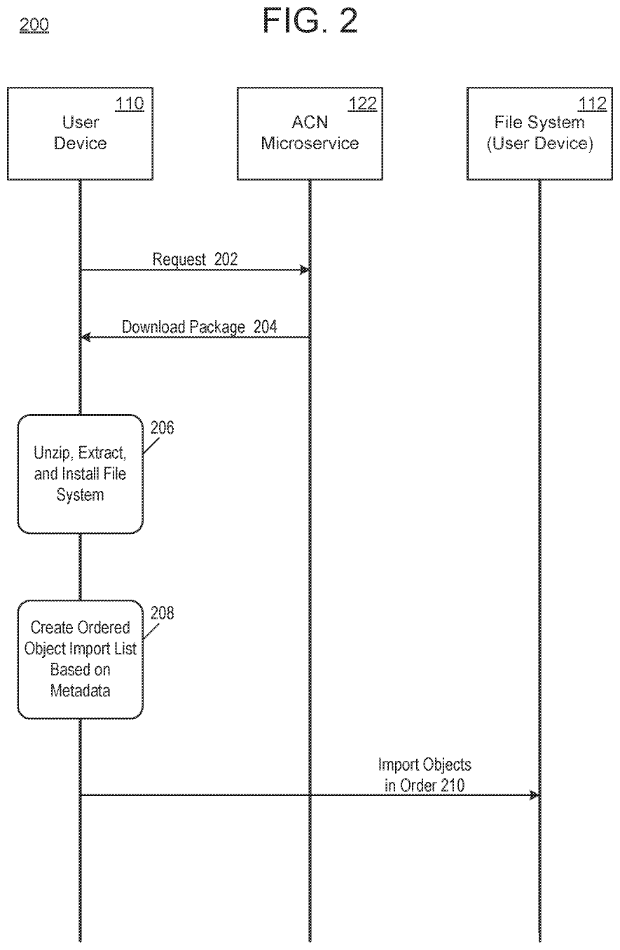

FIG. 2 illustrates a communication sequence 200 for importing content into a cloud environment in accordance with an example embodiment. In the examples discussed further herein, the communication sequence 200 may be performed by the user device 110 and the cloud platform 120 shown in the examples of FIGS. 1A-1C, however embodiments are not limited thereto. It should also be appreciated that the processes and methods described herein may be carried out by different devices on different systems.

Once invoked, the script described herein may perform the import steps such as steps 208, 210, etc., shown in FIG. 2 in order to import content from the cloud platform such as a cloud data store, database, blob store, or the like, into a local file system on the user device.

For example, referring to FIG. 2, in 202, the user device 110 may submit a request to the host platform/cloud platform for a specific piece of content from a cloud data store. Here, the request is submitted to the microservice 122 which, in 204, provides a package to the user device 110 in response to the request 202 from the user device 110. As an example, the package 204 may include a zip package. In 206, the user device 110 may unzip the files included in the received package, decode any content in the unzipped data if necessary and extract unzipped content and store it locally within a file system of the user device 110. An object within the package may include the script. Another object in the package may include the metadata with instructions to be used by the script during execution of the script. The metadata may include identifiers of data artifacts that are to be stored within the file system on the user device 110 along with instructions on an order in which the objects are to be stored.

In this example, the user device 110 may invoke the script which identifies the objects downloaded from the cloud and the instructions for storing the objects locally on the file system 112 of the user device 110. Here, the script can import content into the local file system without the user device 110 being online or network connected to the cloud platform 120. In particular, the metadata/instructions downloaded from the cloud may include an ordering of the objects. The order represents a chronological order in which the objects should be added to the file system 112 on the user device 110. Upon request of the user or upon some automated condition, the user device 110 may import the cloud content downloaded from the cloud platform 120 into the file system 112 on the user device 110. This may occur after the user device 110 is offline.

For example, in 208, the script may read the metadata included in the package exported in 204 to identify a list of data artifacts that are to be stored in the file system 112. The script may convert the data artifacts into objects that can be stored within the file system 112 and send the converted data artifacts to the file system 112 in the order specified by the metadata, in 210. The import list of artifacts may be sorted based on dependencies among the artifacts themselves. Based on the order, each artifact may be sequentially imported by sending a REST http request with a payload containing all the necessary information needed by the EPM endpoint responsible for creating the objects in the file system 112.

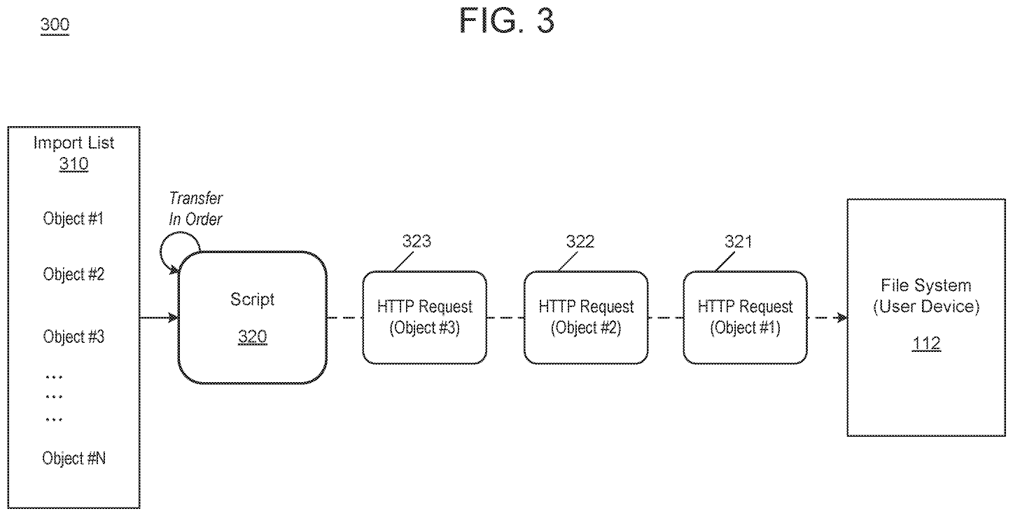

FIG. 3 illustrates a process 300 of transferring objects of content via a script 320 running on the user device 110 to the file system 112 held locally on the user device 110 in accordance with an example embodiment. Referring to FIG. 3, the script 320 downloaded from a host microservice such as the microservice 122 shown in the example of FIG. 1A may be executed locally by a user device such as the user device 110 shown in the example of FIG. 1A. Invocation of the script 320 may be triggered by a user or some other condition. In response, the script 320 may perform an import process to cause files downloaded from the cloud to be imported into a local file system (the file system 112) of the user device 110.

The object import workflow is dictated by the package metadata and in turn, the type of the data artifacts to be imported. As an example, high level object types may include an Enterprise Performance Management (EPM) object type and EPM object data. The EPM object type usually represents a table or a dimension that will be created in a database and the EPM object data represents the content or rows which of data vales that will be inserted into a given table. Another example of an object is a dimension of the table. The dimensions may be used to represent a collection of “related” objects. For example, objects may be related to each other using dimensions such as product name, product category, size, price, etc. The table may include multiple dimensions including more than two dimensions. The script 320 may generate an import list 310 with an ordered list of objects such as objects 321, 322, and 323 to be imported into the cloud. The script 320 may iterate through the import list 310, read the entries, and create the objects 321, 322, and 323, sequentially. The objects 321, 322, and 323 may then be transferred to the file system 112 on the user device 110 in the order defined by the metadata in the exported package.

The objects that are imported to the user device may be transferred into the file system on the user device by the invocation of the script. Here, the script may import the metadata from the package, create a temporary table in a local data store and add the objects that are to be imported to the cloud platform into the temporary table. The objects may be ordered in sequence in the order they should be transmitted to the cloud. Each object may be converted into a payload that is added to a respective request message that is then transmitted from the script 320 to the file system 112 on the user device 110. When the script 320—reaches the end of the import list (table), the script 320 may delete the temporary table from the local storage.

The example embodiments enable a developer to download cloud content out of the cloud storage environment and use it in a local user environment even when the local user environment is not connected to a network or the cloud platform. The developer does not need to be connected to the cloud or a network while the developer interacts with the cloud data locally in the local user environment such as testing software programs, etc. Thus, the developer could be offline while still being able to test the software in a remote manner using data directly downloaded from the cloud.

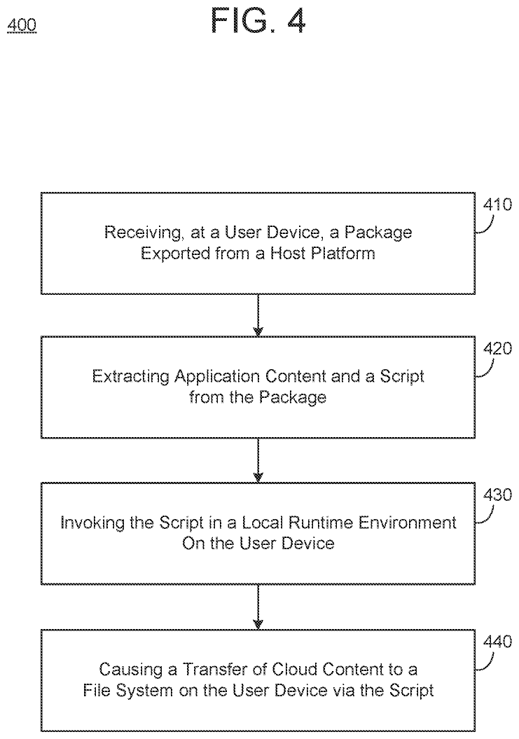

FIG. 4 illustrates a method 400 of importing content from a local environment into a remote host platform in accordance with an example embodiment. For example, the method 400 may be performed by a software application hosted by the host platform such as a cloud platform, a web server, a distributed system, a database, or the like. Referring to FIG. 4, in 410, the method may include receiving a package exported from a host platform. As an example, the package may include a zip file which can be unzipped by the system.

In 420, the method may include extracting content of a software application hosted on the host platform and a script from the exported package. In 430, the method may include installing the content of the software application within a file system on a user device. In 440, the method may include modifying the content of the software application based on user input received through an input mechanism of the user device. In 450, the method may include causing, via the script, a transfer the modified content of the software application from the file system to an application programming interface (API) of the host platform.

In some embodiments, the method may further include enabling the script to access the file system within a local storage on the user device. In some embodiments, the extracting may further include extracting metadata from the exported package, and the causing comprises causing the transfer of the modified content of the software application from the file system to the host platform based on import instructions included in the extracted metadata. In some embodiments, the instructions included in the extracted metadata may include identifiers of a plurality of database artifacts that are to be imported from the user device to the host platform, and dependencies among the plurality of database artifacts indicating an order in which the plurality of database artifacts are to be imported from the computing system to the host platform.

In some embodiments, the exporting comprises exporting a zipped file from the host platform and unzipping the zipped file to obtain the content of the software application and the script. In some embodiments, the method may further include ordering the plurality of database artifacts into a sequence based on the script and transferring the plurality of database artifacts via a sequence of corresponding API calls to the API of the host platform. In some embodiments, the sequence of API calls may include a sequence of hypertext transfer protocol (HTTP) requests, and each HTTP request includes a respective payload of the modified content of a database artifact. In some embodiments, the method may further include building a temporary table, storing the sequential order of the plurality of database artifacts in the temporary table, and transferring the plurality of database artifacts to the host platform in the sequential order based on the temporary table.

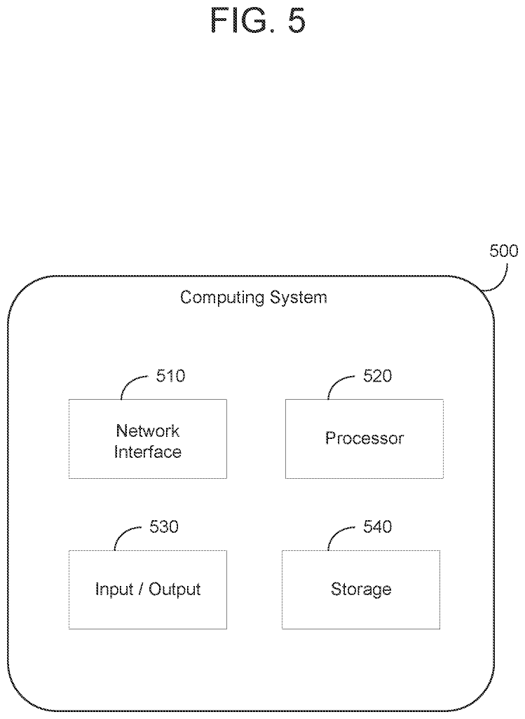

FIG. 5 illustrates a computing system 500 that may be used in any of the methods and processes described herein, in accordance with an example embodiment. For example, the computing system 500 may be a database node, a server, a cloud platform, or the like. In some embodiments, the computing system 500 may be distributed across multiple computing devices such as multiple database nodes. Referring to FIG. 5, the computing system 500 includes a network interface 510, a processor 520, an input/output 530, and a storage 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage 540, or a combination thereof, may interact with applications executing on other devices.

The storage 540 is not limited to a particular storage device and may include any known memory device such as RAM, ROM, hard disk, and the like, and may or may not be included within a database system, a cloud environment, a web server, or the like. The storage 540 may store software modules or other instructions which can be executed by the processor 520 to perform the methods described herein. According to various embodiments, the storage 540 may include a data store having a plurality of tables, records, partitions and sub-partitions. The storage 540 may be used to store database records, documents, entries, and the like.

As one example, the storage 540 may correspond to a local storage of a user device that is remote from a host platform such as a cloud platform. In this example, the storage 540 may store/host a file system that includes a directory or multiple directories of folders, files, etc. The files may be accessed through file paths of the file system. The network interface 510 may retrieve/receive a package exported from a host platform. For example, the network interface 510 may download a zip package from the host platform. The processor 520 may extract content of a software application and a script from the exported package. The processor 520 may install the content of the software application within the file system. The processor 520 may invoke the script and cause, via the invocated script, a transfer of objects from the cloud in the exported package into the file system within the storage 540.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), cloud storage, and the like. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a local storage comprising a file system;
a network interface configured to receive a package exported from a host platform; and
a processor configured to:
extract content of a software application and a script from the exported package,
install the script from the exported package at the computing system, and
execute the script via a local runtime environment of the computing system and cause, via execution of the script, objects of cloud content of the software application included in the exported package to be transferred to the file system included in the local storage.

2. The computing system of claim 1, wherein the processor is further configured to enable the script to access the file system within the local storage.

3. The computing system of claim 1, wherein the processor is further configured to extract metadata from the exported package, and cause the transfer of the objects of cloud content downloaded from the host platform to the file system based on import instructions included in the extracted metadata.

4. The computing system of claim 3, wherein the instructions included in the extracted metadata comprise identifiers of a plurality of database artifacts that are to be imported, and dependencies among the plurality of database artifacts indicating an order in which the plurality of database artifacts are to be imported.

5. The computing system of claim 1, wherein the processor is configured to export a zipped file from the host platform and unzip the zipped file to obtain the content of the software application and the script.

6. The computing system of claim 1, wherein the processor is configured to sequentially order a plurality of database artifacts into a sequence and transfer the sequentially-ordered plurality of database artifacts via a sequence of calls to the file system included in the local storage.

7. The computing system of claim 6, wherein the sequence of calls comprises a sequence of hypertext transfer protocol (HTTP) requests that include payloads of the content from the plurality of database artifacts, respectively.

8. The computing system of claim 6, wherein the processor is configured to build a temporary table via the script, store the sequential order of the plurality of database artifacts in the temporary table, and transfer the plurality of database artifacts to the file system in the sequential order based on the temporary table.

9. A method comprising:
receiving, at a user device, a package exported from a host platform;
extracting content of a software application hosted on the host platform and a script from the exported package;
invoking the script within a runtime environment on the user device; and
causing, via the script, a transfer objects of cloud content of the software application which are included in the exported package to a file system that is installed in a local storage on the user device.

10. The method of claim 9, wherein the method further comprises enabling the script to access the file system within the local storage on the user device.

11. The method of claim 9, wherein the extracting further comprises extracting metadata from the exported package, and causing the transfer of the objects of cloud content downloaded from the host platform to the file system based on import instructions included in the extracted metadata.

12. The method of claim 11, wherein the instructions included in the extracted metadata comprise identifiers of a plurality of database artifacts that are to be imported, and dependencies among the plurality of database artifacts indicating an order in which the plurality of database artifacts are to be imported.

13. The method of claim 9, wherein the exporting comprises exporting a zipped file from the host platform and unzipping the zipped file to obtain the content of the software application and the script.

14. The method of claim 9, wherein the method further comprises sequentially ordering a plurality of database artifacts into a sequence and transferring the sequentially-ordered plurality of database artifacts via a sequence of calls to the file system included in the local storage.

15. The method of claim 14, wherein the sequence of calls comprises a sequence of hypertext transfer protocol (HTTP) requests, and each HTTP request includes a respective payload of content of a database artifact.

16. The method of claim 9, wherein the method further comprises building a temporary table via the script, storing a sequential order of a plurality of database artifacts in the temporary table, and transferring the plurality of database artifacts to the file system in the sequential order based on the temporary table.

17. A computer-readable medium comprising program instructions which when executed by a processor cause a computer to perform a method comprising:
receiving, via a user device, a package exported from a host platform;
extracting files of a software application hosted on the host platform and an executable script from the exported package;
invoking the executable script within a runtime environment on the user device; and
causing, via the script, a transfer objects of cloud content of the software application which are included in the exported package to a file system that is installed in a local storage on the user device.

18. The computer-readable medium of claim 17, wherein the extracting further comprises extracting metadata from the exported package, and causing the transfer of the objects of cloud content downloaded from the host platform to the file system based on import instructions included in the extracted metadata.

19. The computer-readable medium of claim 17, wherein the exporting comprises exporting a zipped file from the host platform and unzipping the zipped file to obtain the content of the software application and the script.

20. The computer-readable medium of claim 19, wherein the method further comprises sequentially ordering a plurality of database artifacts into a sequence via the script and transferring the sequentially-ordered plurality of database artifacts via a sequence of calls to the file system included in the local storage.
